(19) United States
(12) Patent Application Publication
(10) Pub. No.: US 2009/0144463 A1
(43) Pub. Date: Jun. 4, 2009

(54) System and Method for Input/Output Communication

(75) Inventors: Jacob Cherian, Austin, TX (US); Gaurav Chawla, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/946,927

(22) Filed: Nov. 29, 2007

(51) Int. Cl. G06F 13/14

(52) U.S. Cl. 710/33

(57) ABSTRACT

Systems and methods for input/output communication are disclosed. A method for communicating data may include communicating metadata from a storage array to a host device, the metadata comprising information regarding data stored on a plurality of storage nodes disposed in the storage array. The method may further include determining, from the metadata, individual I/O requests to be communicated to each of the plurality of storage nodes. The host device may communicate the individual I/O requests to the plurality of storage nodes. Each of the plurality of storage nodes may execute the I/O operations responsive to the individual I/O requests.

### TECHNICAL FIELD

The present disclosure relates in general to input/output (I/O) communication, and more particularly I/O communication in a storage network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput and/or capacity. In operation, one or more storage resources disposed in an array of storage resources may appear to an operating system as a single logical storage unit or “logical unit.” Implementations of storage resource arrays can range from a few storage resources disposed in a server chassis, to hundreds of storage resources disposed in one or more separate storage enclosures.

Often, instead of using larger, monolithic storage systems, architectures allowing for the aggregation of smaller, modular storage systems to form a single storage entity, “a scaled storage array” (or storage array), are used. Such architectures may allow a user to start with a storage array of one or few storage systems and grow the array in a capacity and performance over time based on need by adding additional storage systems. The storage systems that are part of a scaled storage array (or storage array) may be referred to as the storage nodes of the array. However, conventional approaches employing this architecture possess inefficiencies and do not scale well when numerous storage resources are included. For example, if a “READ” or “DATA IN” request is communicated to a storage array comprising multiple storage nodes, one of the storage nodes may receive and respond to the request. However, if all of the requested data is not present on the storage node, it may need to request the remaining data from the other storage nodes in the storage array. Often, such remaining data must be communicated over a data network to the original storage node receiving the READ request, then communicated again by the original storage node to the information handling system issuing the READ request. Thus, some data may be required to be communicated twice over a network. Accordingly, such conventional approach may lead to network congestion and latency of the READ operation. Also, because such congestion and latency generally increases significantly as the number of storage nodes in the storage array increases, the conventional approach may not scale well for storage arrays with numerous storage nodes.

An illustration of disadvantages of conventional approaches is depicted in FIGS. 1A and 1B. FIGS. 1A and 1B each illustrate a flow chart of a conventional method 100 for reading data from a plurality of storage nodes disposed in a storage array. In particular, as shown in FIGS. 1A and 1B, a host device may issue a command to read data from storage array, wherein a portion of the data is stored in a first storage node, another portion of the data is stored in a second storage node, and yet another portion of the data is stored in a third storage node.

As depicted in FIGS. 1A and 1B, the first storage node which receives the request for data, provides a portion of the data stored locally on the storage node. The first storage node then issues its own request to one or more other storage nodes which contain a remainder of the requested data. The other storage nodes transfer the data to the original storage node, which then transfers the data back to the host, to complete transfer of all data requested in the read operation.

For example, at step 102 of FIG. 1A, a host device may issue a READ command to the first storage node. At step 104, the first storage node may communicate to the host device the portion of the data residing on the first storage node. At step 106, the first storage node may issue its own READ command to a second storage node. In response, at step 108, the second storage node may communicate to the first storage node the portion of the data residing on the second storage node, after which, at step 110, the second storage node may communicate to the first storage node a STATUS message to indicate completion of the data transfer from the second storage node. At step 112, the first storage node may communicate to the host device the portion of the data that was stored on the second storage node.

Similarly, at step 114, the first storage node may issue a READ command to a third storage node. At step 116, the third storage node may communicate to the first storage node the portion of data residing on the third storage node, and then communicate to the first storage node a STATUS message to indicate the completion of the data transfer at step 118. At step 120, the first storage node may communicate to the host device the portion of the data that was stored on the third storage node. At step 122, the first storage node may communicate to the host device a status message to indicate completion of the transfer of the requested data. After completion of step 122, method 100 may end.

While method 100 depicted in FIGS. 1A and 1B may successfully communicate data from a storage array to a host device, method 100 may suffer from numerous drawbacks. For example, because data read from each of the second and third storage nodes must be communicated over a network twice (e.g., for the portion of the data stored on the second storage node: once from the second storage node to the first storage node as depicted in step 108, then from the first storage node to the host device at step 112), the method 100 may lead to network congestion and latency of the READ operation. Also, because such congestion and latency increases significantly as the size of a storage array increases, the conventional approach may not scale well for storage arrays with numerous storage nodes.

### SUMMARY

In accordance with the teachings of the present disclosure, the disadvantages and problems associated with data storage and backup have been substantially reduced or eliminated. In a particular embodiment, a method may include communicating metadata from a storage array to a host device, the metadata comprising information regarding data stored on a plurality of storage nodes disposed in the storage array, and from the metadata, determining individual I/O requests to be communicated to each of the plurality of storage nodes.

In accordance with one embodiment of the present disclosure, a method for input/output (I/O) communication is provided. The method may include communicating metadata from a storage array to a host device, the metadata comprising information regarding data stored on a plurality of storage nodes disposed in the storage array. The method may further include determining, from the metadata, individual I/O requests to be communicated to each of the plurality of storage nodes. The host device may communicate the individual I/O requests to the plurality of storage nodes. Each of the plurality of storage nodes may execute the I/O operations responsive to the individual I/O requests.

In accordance with another embodiment of the present disclosure, a system for input/output communication may include a host device and a storage array having a plurality of storage nodes, each of the plurality of storage nodes communicatively coupled to the host device and to each other. The host device may be operable to receive from the storage array metadata comprising information regarding data stored on the plurality of storage nodes. The host device may also be operable to, from the metadata, determine individual I/O requests to be communicated to each of the plurality of storage nodes. The host device may be further operable to communicate the individual I/O requests to the plurality of storage nodes. Each of the plurality of storage nodes may be operable execute the I/O operations responsive to the individual I/O requests.

In accordance with a further embodiment of the present disclosure, an information handling system may include a memory and a processor communicatively coupled to the memory. The processor may be operable to execute a program of instructions. The program of instructions may be operable to (a) receive metadata from a storage array communicatively coupled to the information handling system, the metadata comprising information regarding data stored on a plurality of storage nodes disposed in the storage array; (b) from the metadata, determine individual I/O requests to be communicated to each of the plurality of storage nodes; and (c) communicate the individual I/O requests from the information handling system to the plurality of storage nodes.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIGS. 1A and 1B each illustrate a flow chart of a conventional method for reading data from a storage array;

FIG. 2 illustrates a block diagram of an example system for reading data from and writing data to a storage array, in accordance with the present disclosure; and

FIGS. 3A, 3B, and 3C each illustrate a flow chart of an example method for input/output (I/O) communication, in accordance with the present disclosure.

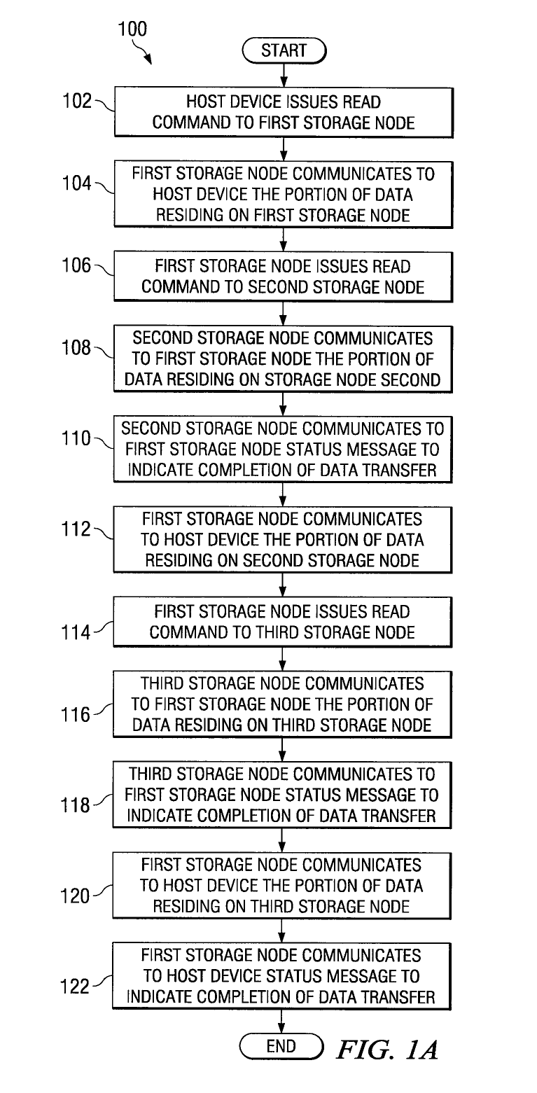

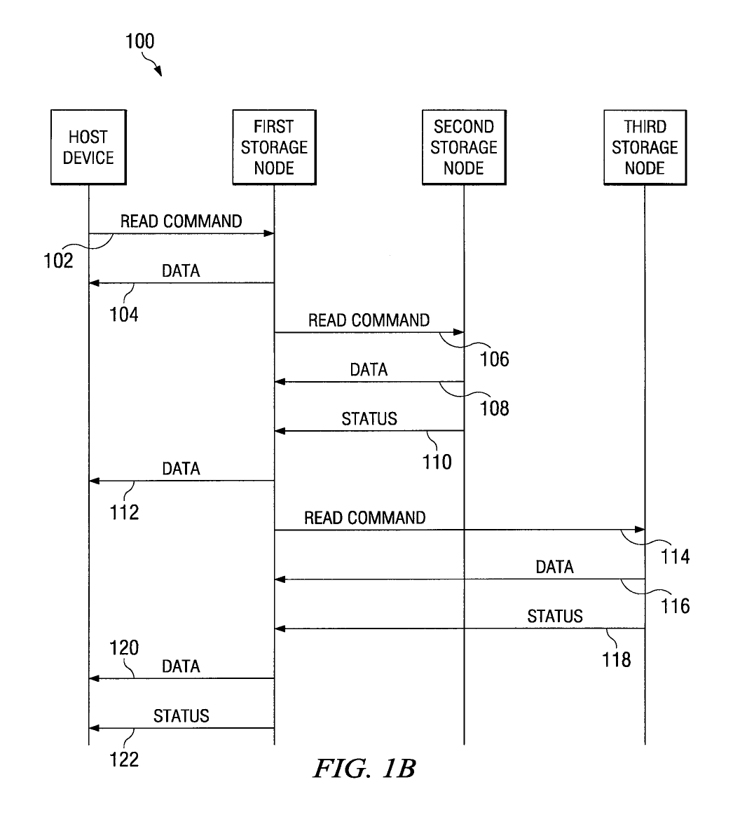

### DETAILED DESCRIPTION

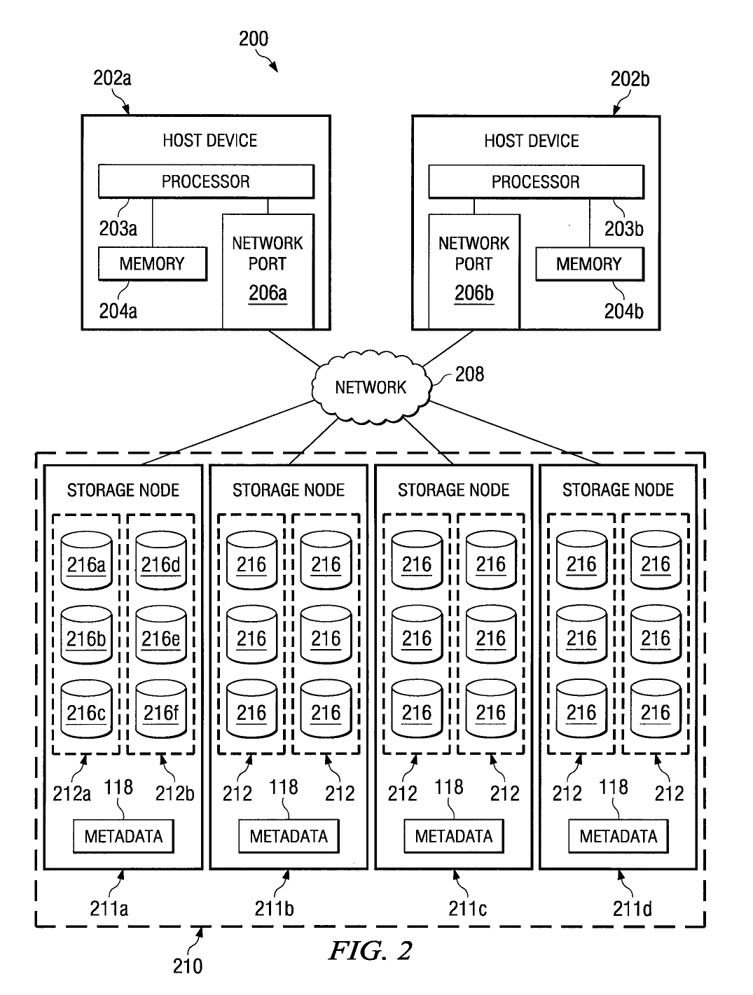

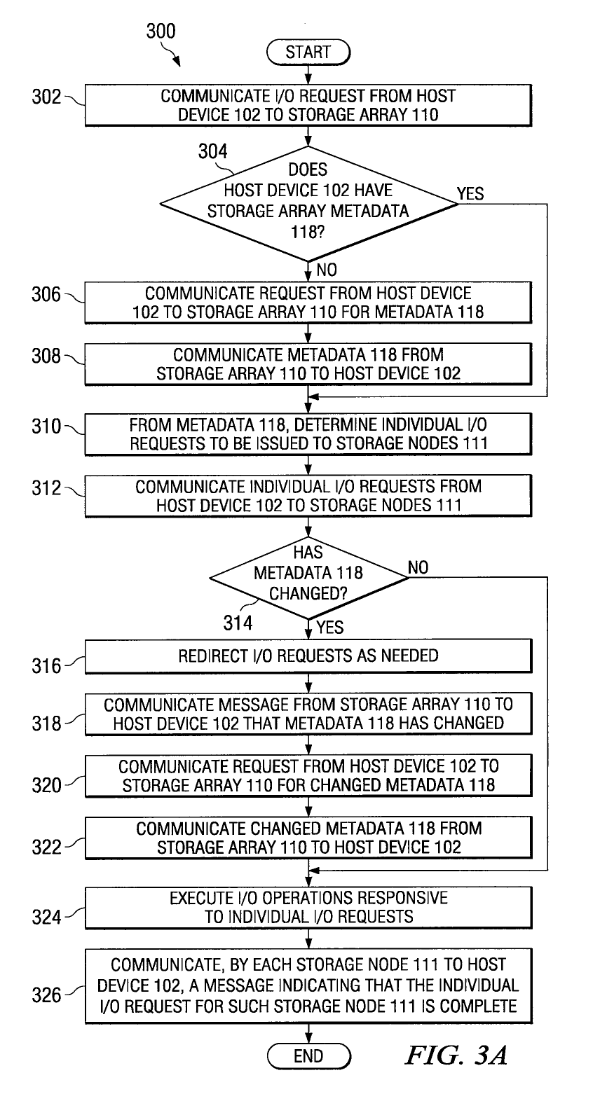

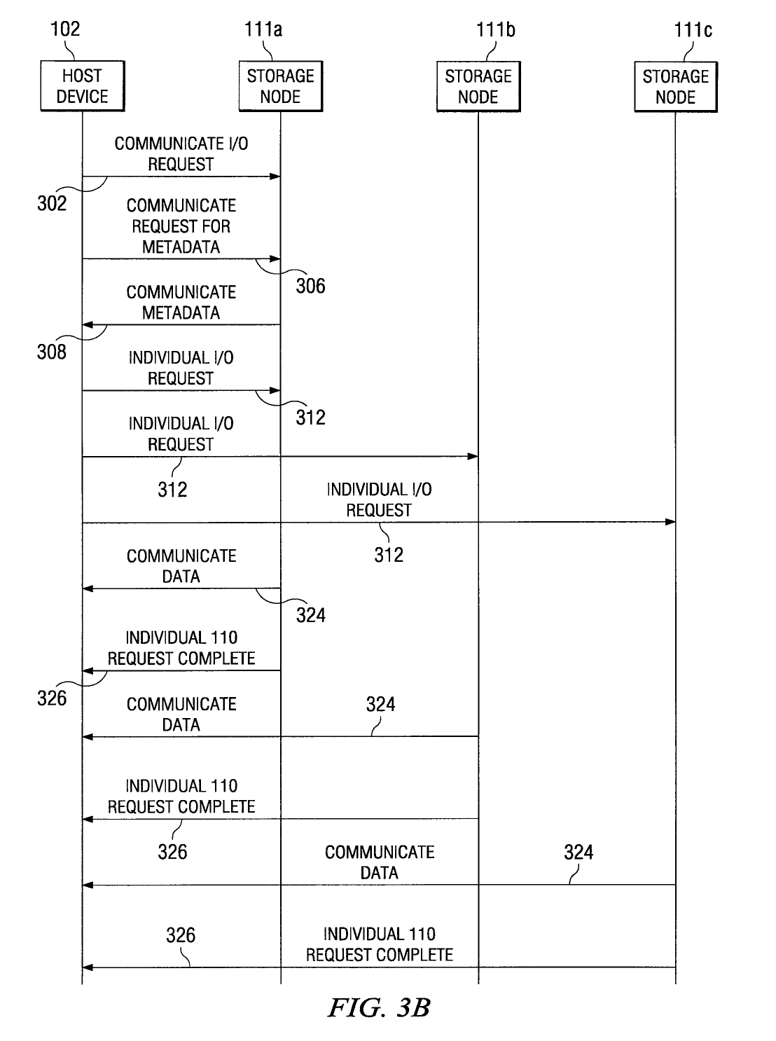

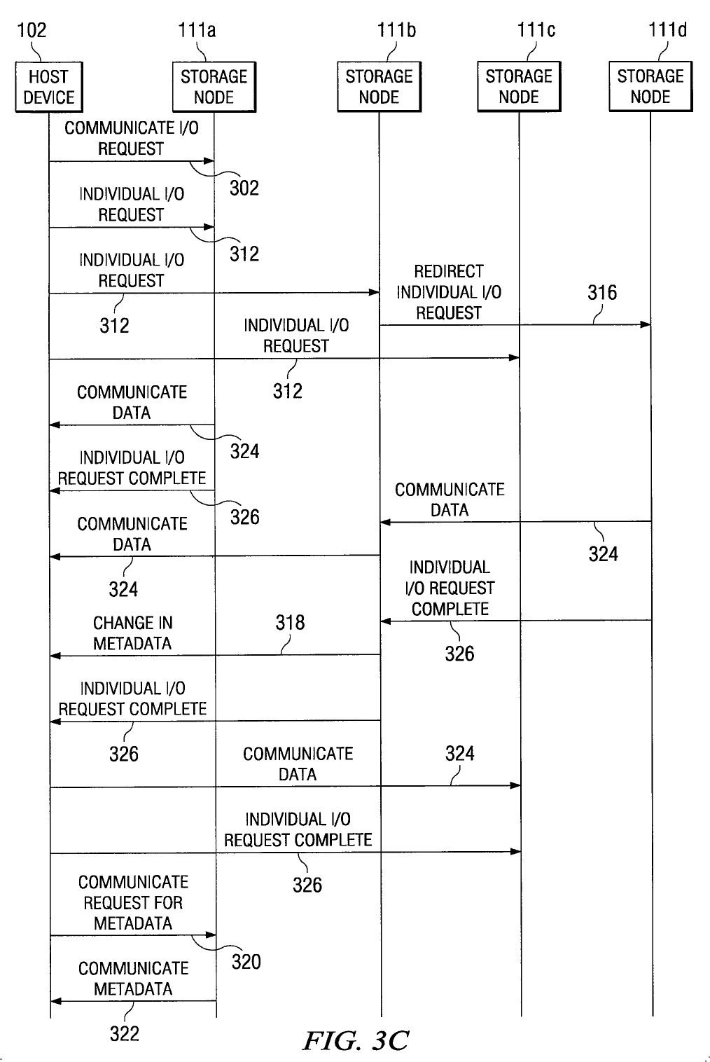

Preferred embodiments and their advantages are best understood by reference to FIGS. 2 through 3C, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

As discussed above, an information handling system may include or may be coupled via a storage network to an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 2 illustrates a block diagram of an example system 200 for reading data from and writing data to a storage array, in accordance with the present disclosure. As depicted in FIG. 2, system 200 may comprise one or more host devices 202, a network 208, and a storage array 210.

Each host device 202 may comprise an information handling system and may generally be operable to read data from and/or write data to one or more logical units 216 disposed in storage array 210. In certain embodiments, one or more of host devices 202 may be a server. As depicted in FIG. 2, each host device may comprise a processor 203, a memory 204 communicatively coupled to processor 203, and a network port 206 communicatively coupled to processor 203.

Each processor 203 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 203 may interpret and/or execute program instructions and/or process data stored in memory 203 and/or another component of host device 202.

Each memory 204 may be communicatively coupled to its associated processor 203 and may comprise any system, device, or apparatus operable to retain program instructions or data for a period of time. Memory 204 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to host device 202 is turned off.

Network port 206 may be any suitable system, apparatus, or device operable to serve as an interface between host device 202 and network 208. Network port 206 may enable host device 202 to communicate over network 208 using any suitable transmission protocol and/or standard, including without limitation all transmission protocols and/or standards enumerated below with respect to the discussion of network 208.

Although system 200 is depicted as having two hosts 202, system 200 may include any number of hosts 202.

Network 208 may be a network and/or fabric configured to couple host devices 202 to storage array 210. In certain embodiments, network 208 may allow hosts 202 to connect to logical units 212 disposed in storage array 210 such that the logical units 212 appear to hosts 202 as locally attached storage resources. In the same or alternative embodiments, network 208 may include a communication infrastructure, which provides physical connections, and a management layer, which organizes the physical connections, logical units 212 of storage array 210, and hosts 202. In the same or alternative embodiments, network 208 may allow block I/O services and/or file access services to logical units 212 disposed in storage array 210.

Network 208 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 208 may transmit data using any communication protocol, including without limitation, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE), and/or any combination thereof. Further, network 208 may transport data using any storage protocol, including without limitation, Fibre Channel, Internet SCSI (iSCSI), Serial Attached SCSI (SAS), or any other storage transport compatible with SCSI protocol. Network 208 and its various components may be implemented using hardware, software, or any combination thereof.

As depicted in FIG. 2, storage array 210 may comprise one or more storage nodes 211, and may be communicatively coupled to host devices 202 and/or network 208, in order to facilitate communication of data between host devices 202 and storage nodes 211. As depicted in FIG. 2, each storage node 211 may comprise one or more physical storage resources 216, and may be communicatively coupled to hosts 202 and/or network 208, in order to facilitate communication of data between hosts 202 and physical storage resources 216. Physical storage resources 216 may include hard disk drives, magnetic tape libraries, optical disk drives, magneto-optical disk drives, compact disk drives, compact disk arrays, disk array controllers, and/or any other system, apparatus, or device operable to store data.

In operation, one or more physical storage resources 216 may appear to an operating system executing on host 202 as a single logical storage unit or virtual resource 212. For example, as depicted in FIG. 2, virtual resource 212a may comprise storage resources 216a, 216b and 216c. Thus, host 202 may “see” virtual resource 212a instead of seeing each individual storage resource 216a, 216b, and 216c. Although in the embodiment depicted in FIG. 2 each virtual resource 212 is shown as including three physical storage resources 216, a virtual resource 212 may comprise any number of physical storage resources. In addition, although each virtual resource 212 is depicted as including only physical storage resources 216 disposed in the same storage node 211, a virtual resource 212 may include physical storage resources 216 disposed in different storage nodes 211.

In addition, each storage node 211 may comprise metadata 218. In general, metadata 218 may comprise information regarding data stored on a plurality of storage nodes 211 disposed in storage array 210. For example, in embodiments in a virtual resource 212 includes physical storage resources 216 from two or more different storage nodes 211, metadata 218 may comprise information regarding the storage resources 216 making up the virtual resource 212, as well as various storage nodes 211 comprising such storage resources 216. In the same or alternative embodiments, a particular file and/or collection of data may span across multiple storage nodes 211. In such embodiments, metadata 218 may comprise information regarding the numerous storage nodes 211 storing the particular file and/or collection of data. In certain embodiments, each storage node 211 may store identical or similar metadata 218, or the metadata 218 present on different storage nodes 111 may include identical or similar information.

Although the embodiment shown in FIG. 2 depicts system 200 having three storage nodes 211, storage array 210 may have any number of storage nodes 211. In addition, although the embodiment shown in FIG. 2 depicts each storage node 211 having six storage resources 216, each storage node 211 of system 200 may have any number of storage resources 216. In certain embodiments, one or more storage nodes 211 may be or may comprise a storage enclosure configured to hold and power one or more physical storage resources 216. In the same or alternative embodiments, one or more storage nodes 211 may be or may solely comprise a singular virtual resource 212. In the same or alternative embodiments, one or more storage nodes 211 may be or may solely comprise a singular physical storage resource 216. Accordingly, as used in this disclosure, “storage node” broadly refers to a physical storage resource, a virtual resource, a storage enclosure, and/or any aggregation thereof.

Although FIG. 2 depicts that host devices 202 are communicatively coupled to storage array 210 via network 208, one or more host devices 202 may be communicatively coupled to one or more physical storage resources 216 without the need of network 208 or another similar network. For example, in certain embodiments, one or more physical storage resources 216 may be directly coupled and/or locally attached to one or more host devices 202.

In operation, system 200 may permit I/O communication between a host node 202 and storage array 210 (e.g., a READ and/or WRITE operation by the host device 202) in accordance with the method described in FIGS. 3A, 3B, and 3C.

The method depicted in FIGS. 3A, 3B and 3C may overcome some or all of the disadvantages of conventional approaches to the communication of data in a storage network. FIGS. 3A, 3B and 3C each illustrate a flow chart of an example method 300 for input/output (I/O) communication, in accordance with the present disclosure. In one embodiment, method 300 includes communicating metadata 218 from a storage array 210 to a host device 202, and from metadata 218, determining individual I/O requests to be communicated to each of the plurality of storage nodes 211.

According to one embodiment, method 300 preferably begins at step 302. As noted above, teachings of the present disclosure may be implemented in a variety of configurations of system 200. As such, the preferred initialization point for method 300 and the order of the steps 302-326 comprising method 300 may depend on the implementation chosen.

At step 302, host device 202 may communicate to storage array 210 and/or storage node 211a disposed in storage array 210 an I/O request. For example, host device 202 may communicate to storage array 210 a “READ” command or a “WRITE” command.

At step 304, host device 202 and/or another component of system 200 may determine whether host device 202 has previously received metadata 118 from storage array 210. If host device 202 has previously received metadata 218 from storage array 210, method 300 may proceed to step 310 where host device 202 may begin communicating individual I/O requests to storage node 210. Otherwise, if host device has not previously received metadata 218 from storage array 210 (e.g., if host device 202 has recently initialized and/or booted, it may not have yet received metadata 218), method 300 may proceed to step 306.

At step 306, host device 202 may communicate a request to storage array 210 and/or a storage node 211 for metadata 218. At step 308, storage array 210 and/or a storage node 211 disposed in storage array 210 may communicate metadata to host device 202 in response to the request of step 306.

At step 310, host device 202 may determine, from metadata 218 previously received and/or received at step 308, individual I/O requests to be communicated to storage nodes 211. At step 312, the individual I/O requests may then be communicated from host device 202 to each of a plurality of storage nodes 211. That is, rather than issue a single I/O request to storage array 210 as shown in method 100, host device 202 may issue individual I/O requests to storage nodes 211 that, in the aggregate, are logically equivalent to the I/O request issued at step 302. In certain embodiments, two or more of the individual I/O requests may be communicated substantially in parallel.

At step 314, storage array 210 and/or one or more storage nodes 211 may determine whether metadata 218 has changed since a previous I/O request to storage array 210. Metadata 218 may change for a variety of reasons. For example, if the physical storage resources 216 making up a virtual resource 212 should change for any reason (e.g., failure and/or rebuild of the virtual resource 212), metadata 218 may update to reflect the change. If it is determined that metadata 218 has changed since a previous I/O request, method 300 may proceed to step 316 where individual I/O requests are redirected and the metadata 318 at host device 202 is updated. Otherwise, if it is determined that metadata has not changed since the previous I/O request, method 300 may proceed to step 324.

In general, FIG. 3B graphically depicts the execution of method 300 in those circumstances in which metadata 318 has not changed since a previous I/O request. On the other hand, FIG. 3C graphically depicts the execution of method 300 in those circumstances in which metadata 318 has changed since a previous I/O request due a move of data from storage node 211b to storage node 211d since the previous I/O request.

At step 316, individual I/O requests from host 202 may be redirected by one or more storage nodes 211 as necessary. For example, as shown in FIG. 3C, if data responsive to an I/O request previously existed on storage node 211b, but since has been moved to storage node 211d, storage node 211b may redirect its associated individual I/O request to storage node 211d, similar to as shown in method. Storage node 211d may then respond to the redirected individual I/O request by communicating data and/or other messages to storage node 211d. Storage node 211b may then communicate data and/or messages received from storage node 211d to host device 202 and/or other components of system 200 in accordance with the present disclosure. In certain embodiments, two or more redirected individual I/O requests may be communicated substantially in parallel.

At step 318, storage array 210 and/or a storage node 211 disposed in storage array 210 may communicate a message to host 202 that metadata 218 has changed. In response, host device 202 may, at step 320, communicate a request to storage array 210 for the changed metadata 318. At step 322, storage array and/or a storage node 211 disposed in storage array 210 may communicate the changed data to host device 202.

At step 324, storage nodes 211 may each execute I/O operations responsive to their associated individual I/O requests. For example, if the I/O request issued at step 302 was a READ command, storage nodes 211 may, at step 324, communicate data responsive to the READ command to host device 202. In certain embodiments, two or more storage nodes 211 may execute operations substantially in parallel.

As step 326, each storage node 211 may communicate to host device 202 a message indicating that the individual I/O request for such storage node is complete. For example, in SCSI implementations, storage nodes 211 may each communicate a “STATUS” message to host device 202. In certain embodiments, two or more storage nodes 211 may communicate their respective completion messages substantially in parallel. After completion of step 326, method 300 may end.

Although FIG. 3 discloses a particular number of steps to be taken with respect to method 300, it is understood that method 300 may be executed with greater or lesser steps than those depicted in FIG. 3. In addition, although FIG. 3 discloses a certain order of steps to be taken with respect to method 300, the steps comprising method 300 may be completed in any suitable order. For example, in certain embodiments, steps 318-322 may complete after steps 324 and/or 326.

Method 300 may be implemented using system 200 or any other system operable to implement method 300. In certain embodiments, method 300 may be implemented partially or fully in software embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource.

Using the methods and systems disclosed herein, problems associated conventional approaches to data communication in a storage array may be improved reduced or eliminated. For example, because the methods and systems disclosed may allow for direct communication between a host device and the plurality of storage nodes to or from which a particular item of data may be read or written, latency and network complexity associated with conventional communication and storage approaches may be reduced.

Although the present disclosure has been described in detail, it should be understood that various changes, substitutions, and alterations can be made hereto without departing from the spirit and the scope of the disclosure as defined by the appended claims.

What is claimed is:

1. A method for input/output (I/O) communication comprising:
communicating metadata from a storage array to a host device, the metadata comprising information regarding data stored on a plurality of storage nodes disposed in the storage array;
from the metadata, determining individual I/O requests to be communicated to each of the plurality of storage nodes;
communicating the individual I/O requests from the host device to the plurality of storage nodes; and
executing, by each of the plurality of storage nodes, I/O operations responsive to the individual I/O requests.

2. A method according to claim 1 comprising:
determining if the host device has previously received the metadata; and
communicating a request from the host device to the storage array for the metadata.

3. A method according to claim 1 comprising determining if the metadata has changed since a previous I/O request to the storage array.

4. A method according to claim 3 comprising, in response to a determination that the metadata has changed, redirecting, by first storage node disposed in the plurality of storage nodes to a second storage node disposed in the plurality of storage nodes, the individual I/O request associated with the first storage node.

5. A method according to claim 3 comprising communicating a message from the storage array to the host device that the metadata has changed since the previous I/O request to the storage array.

6. A method according to claim 3 comprising communicating a request from the host device to the storage array for the changed metadata.

7. A method according to claim 6 comprising communicating the changed metadata from the storage array to the host device in response to the request from the host device for the changed metadata.

8. A system for input/output (I/O) communication comprising:
a host device; and
a storage array having a plurality of storage nodes, each of the plurality of storage nodes communicatively coupled to the host device and to each other;
the host device operable to:
receive from the storage array metadata comprising information regarding data stored on the plurality of storage nodes;
from the metadata, determine individual I/O requests to be communicated to each of the plurality of storage nodes; and
communicate the individual I/O requests to the plurality of storage nodes; and
each of the plurality of storage nodes operable to execute the I/O operations responsive to the individual I/O requests.

9. A system according to claim 8 comprising the host device further operable to:
determine if the host device has previously received the metadata; and
communicate a request to the storage array for the metadata.

10. A system according to claim 8 comprising the storage array further operable to determine if the metadata has changed since a previous I/O request to the storage array.

11. A system according to claim 10 comprising:
a first storage node disposed in the plurality of storage nodes; and
a second storage node disposed in the plurality of storage nodes;
the first storage node operable to, in response to a determination that the metadata has changed, redirect to the second storage node the individual I/O request associated with the first storage node.

12. A system according to claim 10 comprising the storage array further operable to communicate a message to the host device that the metadata has changed since the previous I/O request to the storage array.

13. A system according to claim 10 comprising the host device further operable to communicate a request from the host device to the storage array for the changed metadata.

14. A system according to claim 13 comprising the storage array further operable to communicate the changed metadata the host device in response to the request from the host device for the changed metadata.

15. An information handling system comprising:
a memory; and
a processor communicatively coupled to the memory, the processor operable to execute a program of instructions, the program of instructions operable to:
receive metadata from a storage array communicatively coupled to the information handling system, the metadata comprising information regarding data stored on a plurality of storage nodes disposed in the storage array;
from the metadata, determine individual I/O requests to be communicated to each of the plurality of storage nodes; and
communicate the individual I/O requests from the information handling system to the plurality of storage nodes.

16. An information handling system according to claim 15 comprising the program of instructions further operable to:
determine if the information handling system has previously received the metadata; and
communicating a request from the host device to the storage array for the metadata.

17. An information handling system according to claim 15 comprising the program of instructions further operable to determine if the metadata has changed since a previous I/O request to the storage array.

18. An information handling system according to claim 15 comprising the program of instructions further operable to communicate a request to the storage array for the changed metadata.

19. An information handling system according to claim 15 comprising the program of instructions further operable to receive the changed metadata from the storage array.

20. An information handling system according to claim 15 comprising the program of instructions further operable to receive a message from the storage array that the metadata has changed since the previous I/O request to the storage array.
